(19) United States
(12) Patent Application Publication
(10) Pub. No.: US 2026/0354462 A1
(43) Pub. Date: Nov. 12, 2026

(54) A Consumable with Foam Configured to Become Granular

(71) Applicant: JT International SA, Geneva (CH)

(72) Inventor: Alec Wright, Guildford (GB)

(73) Assignee: JT International SA, Geneva (CH)

(21) Appl. No.: 19/118,189

(22) PCT Filed: Nov. 16, 2023
(86) PCT No.: PCT/EP2023/082100

§ 371 Date: Apr. 3, 2025

(30) Foreign Application Priority Data
Nov. 17, 2022 (EP) 22208055.8

(51) Int. Cl. A24F 40/44; A24B 15/167; A24F 40/10; A24F 40/42; H05B 3/03

(52) U.S. Cl. CPC A24F 40/44; A24B 15/167; A24F 40/10; A24F 40/42; H05B 3/03

(57) ABSTRACT

A consumable for a vapour provision device including a porous carbon-based foam. The porous carbon-based foam is configured to hold a vapour precursor material. The porous carbon-based foam is electrically conductive and is configured to make electric contact with one or more electrodes to receive an electric current. The porous carbon-based foam is configured to increase in temperature to volatilise at least some of the vapour precursor material when electric current is received from the one or more electrodes and to become granular when exhausted of vapour precursor material.

The present disclosure relates to a consumable for a vapour provision device and a system comprising a vapour provision device with the consumable.

### BACKGROUND

The popularity and use of reduced-risk or modified-risk devices (also known as vaporisers, vapour provision device or aerosol generating devices) has grown rapidly in the past few years as an aid to assist habitual smokers wishing to quit smoking traditional tobacco products such as cigarettes, cigars, cigarillos, and rolling tobacco. Various devices and systems are available that heat or warm vaporizable substances as opposed to burning tobacco in conventional tobacco products. Many kinds of electric smoking devices are available on the market. The most popular are known as e-cigarettes and vaporize an e-liquid to an inhalable vapor.

A commonly available device is the aerosol generating device or heat-not-burn device. Devices of this type generate aerosol or vapour by heating an aerosol substrate that typically comprises moist leaf tobacco or other suitable vaporizable material to a temperature typically in the range 150 °C to 350 °C. Heating an aerosol substrate, but not combusting or burning it, releases aerosol that comprises the components sought by the user but not the toxic and carcinogenic by-products of combustion and burning. Furthermore, the aerosol produced by heating the tobacco or other vapour precursor material does not typically comprise the burnt or bitter taste resulting from combustion and burning that can be unpleasant for the user and so the substrate does not therefore require the sugars and other additives that are typically added to such materials to make the smoke and/or vapour more palatable for the user.

Another commonly available device is a vapour provision device. The vapour provision device vaporises a vapour precursor material, typically in liquid form. The vapour provision device often comprises a wicking material, for example cotton or ceramic, combined with a heater material, such as a wire or heater track. This is disadvantageous because it requires the vapour precursor material to move from one area to another within the device before vaporisation can occur, which can lead to clogging and also requires the vapour precursor material to have a relatively low viscosity to enable it to flow through the device. The vapour provision device and/or consumable typically comprise reservoirs which retain the vapour precursor material before the vapour precursor material moves to the wicking material for vaporisation. Reservoirs normally require ample space within the device to hold the vapour precursor material causing devices to be bulky. Furthermore, counterfeit or third-party vapour precursor material may be used as a refill after the initial vapour precursor material within the reservoirs has been exhausted.

When all of the liquid in the consumable has evaporated, it leads to dry puffing. This is disadvantageous because it provides a significantly lower sensory experience for a user and is undesirable.

It is an object of the present invention to overcome at least some of the above-mentioned problems.

### SUMMARY

One of the aims of the invention is to provide a consumable for a vapour provision device which prevents or reduces the possibility of dry puffing vapour precursor material

According to the present disclosure there is provided a consumable for a vapour provision device comprising: a porous carbon-based foam configured to hold a vapour precursor material, wherein the porous carbon-based foam is electrically conductive and is configured to make electric contact with one or more electrodes to receive an electric current, wherein the porous carbon-based foam is configured to increase in temperature to volatilise at least some of the vapour precursor material when electric current is received from the one or more electrodes, wherein the foam is configured to become granular when exhausted of vapour precursor material.

Advantageously, due to the carbon-based foam becoming granular when the vapour precursor material has been exhausted from the foam, dry puffing is reduced or prevented. Dry-puffing provides an undesirable experience for a user. This consumable also provides a means to prevent a counterfeit or third party vapour precursor material being used as a refill after the initial vapour precursor material has been exhausted.

The foam's structure may be maintained by a binder material. The binder material may comprise glycerol. The binder material helps to maintain the foam structure and hold the carbon-based material together. The binder may be present in an amount of between 5 and 40 wt. % based on the total weight percentage of the carbon-based foam prior to drying. Advantageously, this amount of binder allows the foam's structure to be maintained but still allows the foam to have flexibility.

The binder may be configured to be volatilised after the vapour precursor material is volatilised. Advantageously, the binder being volatilised may cause the carbon-based foam becoming granular meaning dry puffing is reduced or prevented. Dry-puffing provides an undesirable experience for a user.

The porous carbon-based foam may comprise a carbon-based material, such as charcoal. Advantageously, the carbon-based material, preferably charcoal, allows for the vapour precursor material to be “held” within the pores whilst also being operable to conduct the current, when voltage is applied in use, to heat the vapour precursor material to generate a vapour. The charcoal may be present in an amount of between 10 to 60% wt., preferably between 15 and 55 wt. % based on the total weight percentage of the carbon-based foam prior to drying. This allows for the foam to have the correct consistency.

The foam may further comprise a flexilibising agent, such as gellan gum. The flexibilising agent ensures flexibility of the foam.

The consumable may comprise a cooling section at an inlet end. The cooling section is provided to reduce the temperature of the generated vapour, therefore providing a better sensory experience for a user by avoiding “hot-puff”.

The consumable may include conductive layers on a periphery to electrically couple with said one or more electrodes. This allows for the electric current to conduct between the two electrodes easily to volatilise at least some of the vapour precursor material.

In one example, the consumable may comprise a substantially cuboidal shape and present reduced dimension in comparison with the conventional tobacco consumables. This allows for ease of insertion/use in a vapour provision device while ensuring a good vapour generating capacity.

The consumable may be flat shaped. The shape provides ease of insertion/use in a vapour provision device. Advantageously, when the consumable is flat shaped, the consumable may heat quicker to provide faster volatilisation of the vapour precursor material.

The consumable may include one or more reservoirs for holding vapour precursor material. The porous carbon-based carrier may be configured to wick the vapour precursor material from the one or more reservoirs during use. The reservoirs allow for more vapour precursor material to be held within the consumable to increase the vapour capacity.

In one example, the vapour precursor material may be self-contained in the foam. The vapour precursor material being self-contained within the carbon-based foam allows the shape of the consumable to be optimised and remove the need for one or more reservoirs. Further, providing a self-contained store of vapour precursor material removes the need for a separate wicking and heater material and enables vapour precursor material of increased viscosity to be used as it will not be wicked within the device. The vapour precursor material being self-contained in the porous carbon-based foam also provides the advantage that reservoirs are not required to retain the vapour precursor material allowing the shape of the consumable to be optimised and more easily held by the user.

According to the present disclosure there is provided a system comprising: vapour provision device comprising electrodes; and the consumable according to the present disclosure.

The electrodes may be configured to sandwich the consumable. Advantageously, the electrodes being in contact with the consumable means that an electric current can pass from one electrode to the other easily to heat the vapour precursor material to a temperature sufficient to vaporise/volatilize the vapour precursor material.

According to the present disclosure there is provided a method of manufacturing a consumable for a vapour provision device comprising: combining a base material, a flexilibising agent, a binder, water and charcoal together to form an intermediate; pressing and heating the intermediate to evaporate the water to create pores; and applying a vapour precursor material to the intermediate.

All of the features contained herein may be combined with any of the above examples and in any combination.

### BRIEF DESCRIPTION OF THE DRAWINGS

Examples of the present disclosure will now be described with reference to the accompanying drawings.

FIG. 1a shows a schematic cross-sectional view of a consumable comprising a porous carbon-based foam, with absorbed vapour precursor material, between two electrodes;

FIG. 1b shows a schematic cross-sectional view of the consumable of FIG. 1a wherein the foam has become granular due to exhaustion of vapour precursor material;

FIG. 2 shows a schematic cross-sectional view of the consumable of FIG. 1, further comprising reservoirs.

FIG. 3 shows a schematic cross-sectional view of a vapour provision device, comprising electrodes and the consumable of FIG. 1.

FIG. 4 shows a flow chart of a method for manufacturing a consumable comprising a porous carbon-based foam; and

FIG. 5 shows a flow chart of a method of vapour production with a device comprising two electrodes and a consumable arranged between the electrodes.

### DETAILED DESCRIPTION

The present disclosure relates to a consumable for use with a vapour provision device. As used herein, the term “vapour precursor material” or “vaporizable material” may refer to a smokable material which may for example comprise nicotine or tobacco and a vaporising agent. Tobacco may take the form of various materials such as shredded tobacco, granulated tobacco, tobacco leaf and/or reconstituted tobacco. Nicotine may be in the form of nicotine salts. Suitable vapour precursor materials (also known as vaporising agents) include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. The vapour precursor material may be at least 40% liquid. In some examples, the vapour precursor material is substantially a liquid that holds or comprises one or more solid particles, such as tobacco.

As used herein, the term “vapour provision device” is synonymous with “aerosol generating device” or “device” may include a vaping/aerosol generating device to deliver a vapour and/or aerosol to a user, including an aerosol for vaping. The device may be portable. “Portable” may refer to the device being for use when held by a user. The device may be adapted to generate a variable amount of aerosol, e.g. by providing current for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapour to be provided (so as to mimic the effect of smoking a conventional combustible smoking article such as a cigarette, cigar or pipe, etc.). The device may include a temperature regulation control to drive the current supplied to the consumable to generate a specified target temperature in the consumable and thereafter to maintain the temperature at the target temperature that enables efficient generation of aerosol/vapour.

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

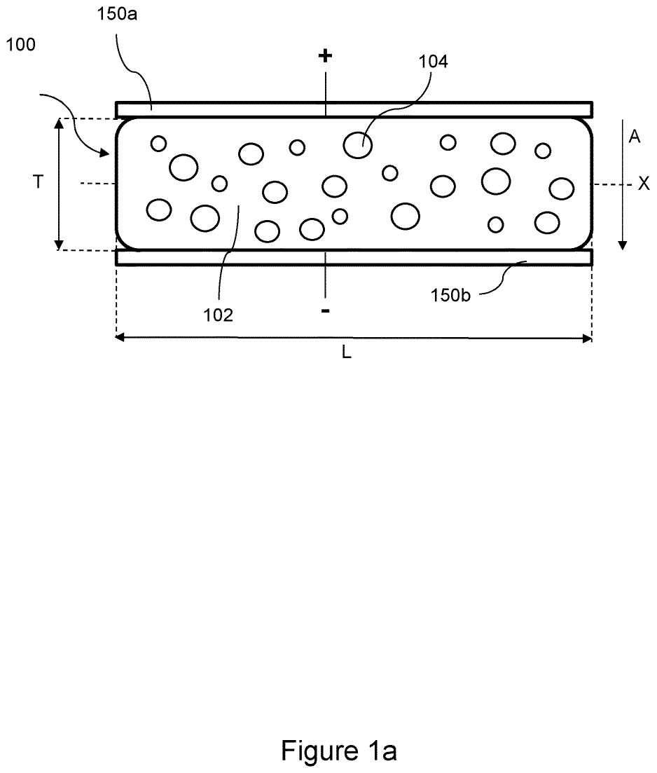

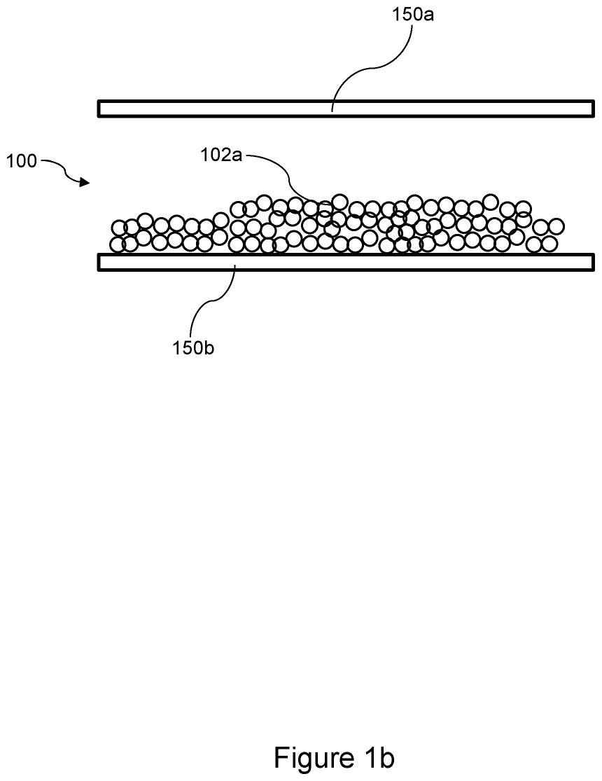

FIG. 1a shows a schematic cross-sectional view of a consumable 100 between two electrodes 150a,b. The consumable 100 comprises a porous carbon-based foam 102 with vapour precursor material 104 contained within pores of the porous carbon-based foam 102. The consumable 100 is arranged between two electrodes 150a,b. In some examples, the consumable 100 is pressed between the electrodes 150a,b. The porous carbon-based foam 102 is electrically conductive and is configured to make electric contact (directly or indirectly) with one or more electrodes 150a,b to receive an electric current. The porous carbon-based foam 102 is configured to conduct electrical current between the two electrodes 150a,b to heat the vapour precursor material 104 to a temperature sufficient to vaporise/volatilise. As will be described in more detail in reference to FIG. 1b, the porous carbon-based foam 102 is configured to become granular when exhausted of vapour precursor material 104.

In one example, the vapour precursor material 104 may be a liquid. The vapour precursor material 104 may comprise any components known to those in the art. For example, the vapour precursor material 104 may comprise a flavorant material (not shown). The flavorant material may be a tobacco material for enhancing the vapour precursor material 104 with an individual tobacco taste and/or may be another flavoring substance (such as menthol) which is added additionally or alternatively to the tobacco material. The flavorant material may be provided as a solid powder.

The term “foam” used herein refers to a uniform or non-uniform porous structure. For example, the consumable may have a substantially hollow structure. The hollow structure can be formed by pores or tubes or another capillary or spongy structure. Such a structure can provide a reserve for vapour precursor material without softening the consumable. The carbon-based foam may comprise carbon-based molecules which form the structure of the foam. For example, the foam may comprise carbon molecules arranged to be in a ring structure, such that the foam is formed from charcoal. The foam may comprise macropores. “Macropores” refers to intermolecular pores between the carbon-based molecules which are operable to absorb the vapour precursor material, such that the vapour precursor material held within the macropores. The carbon-based foam may also comprise micropores. “Micropores” refers to intramolecular pores being present within the carbon-based molecules, which are operable to retain the vapour precursor material.

The term “granular” as used herein refers to powder or solid particulates which comprises less than 50 wt. % of a liquid based on the total weight of the powder, such as less than 40 wt. %, such as less than 30 wt. %, such as less than 20 wt. %, such as less than 10 wt. %, preferably less than 5 wt. %, or even less than 2 wt. % of a liquid based on the total weight of the powder. For example, the term “granular” refers to powder or solid particulates which are substantially free of liquid. The term “substantially free” as used in this context means the powder/solid particulates contain less than 1000 parts per million (ppm). Preferably, the foam becomes granular in the form of a charcoal powder. In other words, in the granular state, the bonds between the carbon molecules have been broken such that a powder is formed.

The porosity of the porous carbon-based foam may be varied by changing the ratio of charcoal to flexilibising agent used in the composition. The flexilibising agent used in the composition may be gellan gum. The ratio of charcoal to flexibilising agent may be from 1:1 to 1:2, such as from 1:1.25 to 1:1.75. Preferably, the porosity of the porous carbon-based foam is between about 40% to about 60%, such as about 50%. The porosity of the porous carbon-based foam may be at least 40%, such as at least 50%.

The porosity of the porous carbon-based foam may be less than 65%, such as 60%. The density of the carbon-based foam may be within the range of about 0.5 to 0.7 g/cm³, for example, between about 0.55 to 0.65 g/cm³.

The vapour precursor material 104 may be self-contained in the porous carbon-based foam 102 prior to volatilisation. For example, the vapour precursor material 104 may be self-contained within pores of the porous carbon-based foam 102. In other words, the vapour precursor material 104 may only be present in the consumable of the device 200 and no vapour precursor material 104 is located in another area of the device 200. This means that no reservoirs are required in the device 200 to hold the vapour precursor material 104 prior to volatilisation. Herein “self-contained” means that substantially all of the vapour precursor material 104 is enclosed within the consumable 100.

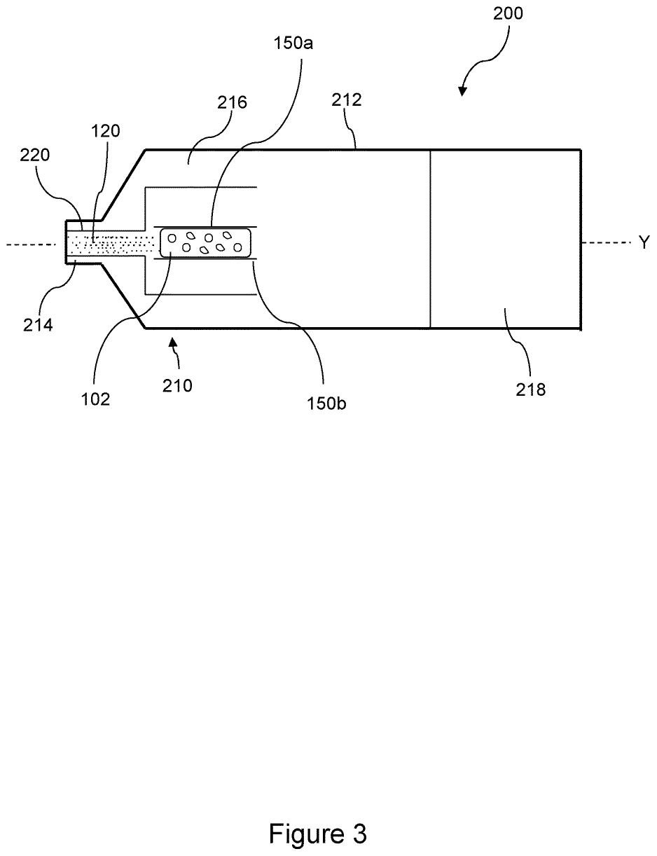

The two electrodes 150a,b preferably represent electrodes in the vapour provision device 200, as shown in FIG. 3. The electrodes 150a,b may be configured to sandwich the consumable 100. For example, the electrodes 150a,b may be pressed on the consumable such that they are in direct or indirect contact with the consumable. The electrodes 150a,b are configured to be in contact with the consumable such that an electrical current may conduct between the two electrodes 150a,b to heat the vapour precursor material 104 to a temperature sufficient to vaporise/volatilise. The electrodes 150a,b may be pressed on the consumable with a pressure of between 0.5 and 10 bar, preferably 5 bar.

In one embodiment, the porous carbon-based foam 102 has an electrical conductivity of at least 1×10³S/m (at 20 °C). A value of electrical conductivity may vary depending on the selected porous carbon-based foam 102. The porous carbon-based foam 102 preferably allows the electric current to flow from the first electrode to the second electrode. Preferably the current flows in a transverse direction (shown as “A” in FIG. 1a) perpendicular to a thickness of the consumable 100. In this context the thickness of the consumable 100 means the thickness of the consumable 100 which is arranged between the first and second electrode 150a,b. In other words, the thickness of the consumable 100 can be considered to be the distance between two main planar faces of the consumable 100 and may typically be the smallest dimension of the consumable 100.

The consumable 100 is for example a flat-shaped cuboid extending along a substrate axis X and having external dimensions L×T×D. In a typical example, the length L of the substrate along the substrate axis X equals substantially 18 mm while its thickness T and depth D (not shown) are substantially equal respectively to 12 mm and 2 mm. According to different examples, the values L, T and D can be selected within a range of +/−40%, for example.

The shape of the consumable 100 enables it to be placed efficiently within a vapour provision device (not shown) and achieve a good contact with electrodes to receive a current.

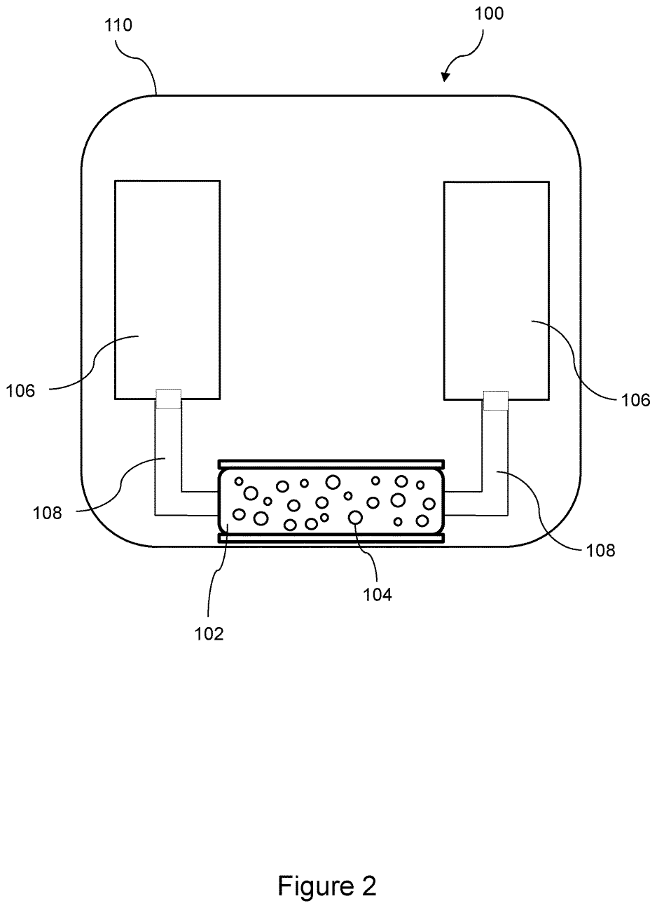

In one example (as shown in FIG. 2), the consumable 100 may also comprise reservoirs 106 suitable for holding additional vapour precursor material 104. In this example, carbon-based foam 102 acts as a wicking material. In this example, the consumable 100 comprises one or more conduits 108 connecting the reservoirs 106 to the carbon-based foam 102 to allow vapour precursor material 104 to move from the reservoirs to the carbon-based foam 102. The consumable 100 may further comprise a cartridge 110 within which the carbon-based foam 102 and the reservoirs 106 are held.

FIG. 1b shows a schematic cross-sectional view of the consumable of FIG. 1a wherein the foam 102 has become granular due to exhaustion of vapour precursor material 104. In this configuration, consumable 100 is no longer pressed between the electrodes 150a,b. In other words, the consumable 100 no longer makes electrical contact with both electrodes 150a,b and so no electric current is conducted between the two electrodes 150a,b.

In use, when the electric current conducts between electrodes 150a,b the temperature of the consumable 100 increases to volatilise at least some of the absorbed vapour precursor material 104. Preferably, the temperature is from 200 to 320 °C. Upon volatilisation, the absorbed vapour precursor material 104 becomes vapour in the form of inhalable aerosol 120. The absorbed vapour precursor material 104 is exhausted from the macropores within the carbon-based foam 102 before exhaustion of the micro-absorbed smokable material 104 retained in the micropores of the particles of the carbon-based foam 102. The vaporisation of the binder material after the vaporisation of the vapour precursor material 104 causes the foam 102 has become granular 102a.

When the is current applied to the electrodes 150a,b, the temperature of the consumable 100 increases to a temperature to volatilise. Firstly, the vapour precursor material becomes vaporised to form of inhalable aerosol/vapour 120. Then, once all of the vapour precursor material 104 becomes inhalable aerosol 120, if a current is still applied electrodes 150a,b, the binder material will be vaporised. The binder material is therefore no longer holding the foam structure together. This causes the bonds between the carbon-based molecules to diminish such that the carbon-based foam becomes granular.

Consumable 100 may comprise a cooling section (not shown) at an inlet end. The inlet end refers to the end of the consumable closest to the user in use, e.g. the proximal end of the consumable. The cooling section may comprise corrugated paper or a cellulose acetate material, preferably, the cooling section comprises corrugated paper. The cooling section may be in direct or indirect contact with carbon-based foam 102, such that the cooling section lowers the temperature of the generated aerosol/vapour 120.

In one example, the consumable comprises one or more conductive layers on a periphery to electrically couple with said one or more electrodes 150a, b.

FIG. 3 shows an example of a vapour provision device 200. The device 200 may comprises a device body 210 extending along a device axis Y and forming at least one side wall 212 of the device 200. The device body 210 may comprise a mouthpiece 214 and a housing 216 arranged successively along the device axis Y. In some examples, the device 200 does not have a specific mouthpiece 214. In such a case, the user's lips are in direct contact with the consumable 100, in use. According to the example of FIG. 3, the mouthpiece 214 and the housing 216 form one single piece. In this case, the side wall 212 has for example a smooth external surface and defines a smooth transition zone between the mouthpiece 214 and the housing 216. According to other examples, the mouthpiece 214 and the housing 216 form two different pieces.

Particularly, according to these examples, the mouthpiece 214 is designed to be fixed on or be received in an insertion opening formed at one of the ends of the housing 216.

In each transversal cross section, the housing 216 may for example form a substantially rectangular shape with rounded edges. In this case, the housing 216 with the mouthpiece 214 form at least four side walls 212. According to other embodiments, the housing 216 can have a round cross-sectional shape. In this case, it can form with the mouthpiece 214 only one side wall. The housing 216 can be sealed at the end opposite to the mouthpiece 214 (if present). The housing 216 and eventually the mouthpiece 214 can be made of any suitable material like aluminium or plastic. In some embodiments, this material can be a thermally conductive material. In some other embodiments, it can be a thermally insulating material.

In some embodiments, the device side wall 212 may comprise one or several openings suitable for arranging control and/or visual elements. For example, such element may comprise actuators, control buttons, touch panels, screens, LEDs, etc.

The housing 216 delimits an internal space of the device 200 receiving various elements designed to carry out different functionalities of the device 200. This internal space can for example receive an electrical energy supply 218 for powering the device 200, the consumable 100, an aerosol channel 220, and a control module (not shown) for controlling the operation of the device 200

It is conceivable that the device 200 comprises further mechanical, electrical and/or electric components. Preferably the electrodes 150a, b are supplied with energy from electrical energy supply 218 (or voltage source) of the vapour provision device 200. Due to this, the vapour provision device 200 preferably does not need an external voltage source (not shown). It is also possible that another embodiment of the device 200 comprises a voltage source which supplies only the electrodes with energy (not shown).

In one example, the voltage source 218 supplies the whole vapour provision device 200 with electrical energy providing a voltage in range of 1 V and 5 V. In a preferred embodiment, the voltage source is a lithium-ion battery delivering a value of 3.7 V. Such a voltage source is particularly advantageous for a modern vapour provision device in view of rechargeability.

The carbon-based foam acts as a conductor between the electrodes 150a,b and provides a means for directly vaporising the vapour precursor material of the consumable 100. Preferably the two electrodes 150a,b and the carbon-based foam reach a temperature in range of 200 to 320 °C for a sufficient aerosolization of the vapour precursor material 104 comprised in the consumable 100.

Preferably the generated aerosol/vapour 120 is guided through the channel 220 to the mouthpiece 214 of the device 200. Due to this, it is conceivable that the channel 220 is connected to the electrodes 150a, b.

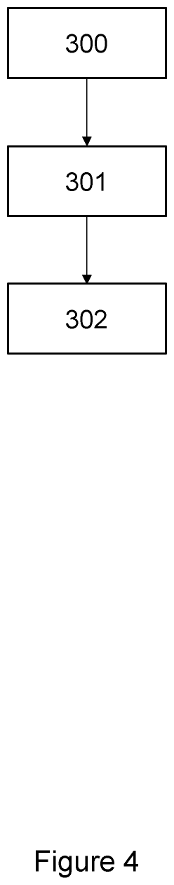

FIG. 4 shows a flow chart of a method for manufacturing a consumable 100 comprising a porous carbon-based foam 102. First step of the method for manufacturing the consumable 100 could preferably be mixing 300 the ingredients of the porous carbon-based foam to provide a smooth mixture. The ingredients may include carbon-based material, such as charcoal, base material, flexbilising agent, binder, and water. For example, the ingredients used to make the carbon-based foam are preferably carboxymethyl cellulose powder, gellan gum, glycerine, water and charcoal. Some, or all, of the vapour precursor material may be mixed with the liquid components at this stage.

To make the consumable, the base material (such as carboxymethyl cellulose powder) is mixed with the flexbilising agent (such as Gellan gum). Next, the binder (such as glycerine (or PG/VG)) is added and then water to make a gel/paste. Finally, the charcoal is added to form the charcoal gum.

It is conceivable to soak porous conductive particles such as charcoal in a vapour precursor material before mixing with the other ingredients. The ingredients are discussed in more detail below. After mixing 300 the ingredients, an intermediate is obtained in form of gum or paste. The next step of the method for manufacturing is preferably the heating step in a press 301. Preferably the heating step 301 comprises heating and mechanical compression of the intermediate for forming a consumable 100 in a layer and the water expands and evaporates to leave pores. It is conceivable that the pressed consumable 100 is arranged between two wrappings after heating step 301. The wrapping layers can be paper layers. As a last step of the method for manufacturing the consumable 100 could be the vapour precursor material step 302. Preferably vapour precursor material is added in the form of, for example, propylene glycol, vegetable glycerin, nicotine and/or flavorant material, such as a tobacco material, menthol, or other flavorant substance, to the pressed consumable 100 during the step 302. The vapour precursor material may be added as a liquid in droplet form to the dried foam. The consumable 100 should comprise a certain amount of moisture for being elastic enough for further use. Preferably, the consumable 100 is heated to about 100 °C and gradually rolled out and cut into a desired shape for use in the device 200.

According to one example, the base material may be carboxymethyl cellulose (CMC), in an amount between 0.5 and 3 wt. % based on the total weight percentage of the carbon-based foam intermediate prior to drying. In particular, the consumable preferably comprises a base material as CMC in an amount between 0.5 and 3 wt. % based on the total weight percentage of the consumable. In an example, the base material is comprised in an amount of about 2.0 and 2.2 wt. % of the total weight percentage of the carbon-based foam prior to drying.

The foam may further comprise a flexilibising agent, such as gellan gum. The flexibilising agent ensures flexibility of the foam. The flexibilisng agent may be present in an amount of 0 and 3 wt. % based on the total weight percentage of the carbon-based foam prior to drying.

The carbon-based foam comprises a binder (such as glycerine (or PG/VG)) to bind the carbon molecules together in an unheated form. The binder may be present in an amount between 5 and 40 wt % based on the total weight percentage of the carbon-based foam prior to drying.

Water enables activation of the binder and its amount can vary according to the binder selected. As mentioned above, this binder will be vapourised during use of the consumable 100, which causes the carbon-based foam to become granular.

Preferably, the carbon-based material (such as charcoal) is in an amount of 10 to 60% wt., preferably between 15 and 55 wt. % based on the total weight percentage of the carbon-based foam in an unheated form. Preferably, the carbon-based material comprises the amount of 20 to 50 wt. %, or even 30 to 50 wt. % based on the total weight percentage of the carbon-based foam in an unheated form. Preferably the amount of present carbon or charcoal particles in the consumable or depends at least on the thickness of the consumable. It is also conceivable that the amount of present carbon or charcoal molecules in the consumable depends on provided pressure between the first and the second electrodes during the heating process. It is possible that the consumable comprises both the carbon and the charcoal molecules. In this case the amount of both materials in the carbon-based foam in an unheated form is preferably present in range of 10% and 60% wt., also preferred 15% and 50% based on the total weight percentage of the consumable. In general, it is conceivable to use a greater amount than 60% wt. of the carbon and/or the charcoal molecules in the consumable.

In one example, the carbon-based foam in an unheated form further comprises water in an amount comprised between 10 and 60 wt. %, preferably between 15 and 50 wt. % based on the total weight percentage of the consumable. For example, the carbon-based foam in an unheated form comprises about 25 wt. % of water.

In one example, the vapour precursor material comprises an amount of less than 25% wt. based on the total weight percentage of the consumable in an unheated form. Preferably, the vapour precursor material comprises glycerin and/or propylene glycol. In this case the carbon-based foam, preferably charcoal, needs a higher temperature for aerosolization of any flavorings comprised in the consumable. In a preferred embodiment, the vapour precursor material comprises an amount of at least 5 wt. % and less than 25 wt. % based on the total weight percentage of the consumable. For example, vaporising agent is glycerin in an amount of about 12.50 wt. %.

In one example, the vapour precursor material comprises tobacco material. The tobacco material comprises tobacco in an amount up to 25 wt. % based on the total weight percentage of the consumable. Preferably, the tobacco material comprises tobacco in an amount between 15 wt. % and 25 wt. % based on the total weight percentage of the consumable. Tobacco may be tobacco powder and/or shredded tobacco such as flue-cured tobacco (FCT). In particular a consumer can use the consumable according to the invention which does not comprise a tobacco powder.

Preferably, the consumable comprising a humectant without tobacco powder is aerosolisable between the electrodes of the aerosol generating device. The humectant preferably comprises flavorings for enhancing the generated aerosol with different flavors. However, the tobacco powder provides a special enlarged tobacco taste of the generated aerosol. It is conceivable that the tobacco powder comprised in the consumable sticks to the carbon-based foam, preferably charcoal, thereby providing nicotine to the generated aerosol.

Preferably, the tobacco powder has a particle size lower than 1000 microns. The tobacco particles may originate from any part of the tobacco plant, e.g. leaves, stems or roots. The particle size of the tobacco powder is crucial in view of the delivered tobacco taste. It has been found that grinding of the tobacco particles to a smaller particle size could affect the odor. It is believed that some of the odorizing molecules decompose due to the high shear energy.

Furthermore, some odorizing molecules could exit too small tobacco particles during the grinding process or during a later handling process. This would result in a depletion of these odorizing molecules in the tobacco particles and an odorizing composition different with respect to the full tobacco odor. In other examples, it is conceivable that the particle size of the tobacco powder used in the consumable is lower than 600 microns or less. The tobacco particles having such a small average particle size are providing a high surface area from which odorizing molecules could leave the particle. Due to this, the small tobacco particles have been found to be important since they provide a full tobacco flavor over a long period.

Preferably, the ratio of solid-to-liquid ingredients content of the consumable is comprised between 70:30 and 30:70, preferably 60:40 to 40:60, more preferably between 55:45 and 50:50, most preferably 52:48. Due to this, the consumable contains enough vaporising agent, may be formed into a sheet without being too brittle while having enough conductive material for conductivity.

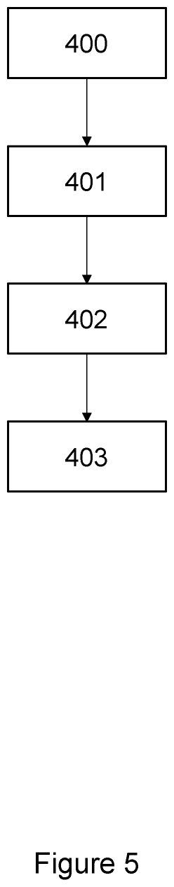

FIG. 5 shows a flow chart of a method for aerosol production with a device 200 comprising two electrodes 150a, b and a consumable 100 arranged between the electrodes 150a, b. The first step of the method for aerosol production is preferably arranging 400 the consumable 100 between the electrodes 150a, b of the device 200. It is also conceivable that the consumable 100 is rolled out and guided to the electrodes 150a, b before the arranging step 400. The method for aerosol production further comprises a pressing step 401, wherein the electrodes 150a, b are pressed with a pressure to the consumable 100. Preferably the electrodes 150a, b are arranged parallel to each other (shown in FIG. 1a) and surround the consumable 100 from two sides or directions. The method further comprises a supplying step 402. The supplying step 402 comprises supplying the electrodes 140a, b with electrical current. Preferably the consumable 100 conducts the current between the two electrodes 150a, b. The carbon-based foam will increase in temperature due to the conduction of the current, which results in an inhalable aerosol/vapour 120 being generated from the vapour precursor material during the heating step 403. When all of the vapour precursor material 104 has been converted to inhalable aerosol 120, the binder material will be volatilize, which results in the carbon-based foam 102 loses its porous structure and becomes granular 102a, preferably in the form of charcoal particles.

### EXAMPLES

A consumable according to the invention was synthesised as follows using the following materials:
Carboxymethyl cellulose powder,
Gellan gum,
Glycerine,
Water,
Charcoal,
Propylene glycol,
Vegetable glycerin,
Nicotine, and
Menthol.

### Example 1

The carbon-based foam was prepared using the following mixture:

| Component | Amount (g) |
|---|---|
| Carboxymethyl cellulose powder | 0.44 |
| Gellan gum | 0 |
| Glycerine | 5.50 |
| Water | 5.06 |
| Charcoal | 9 |

The charcoal gum mixture was formed, as described above.

The charcoal gum mixture was then heated in a press such that the water expands forming pores within the charcoal gum to form a charcoal foam.

Propylene glycol, vegetable glycerin, nicotine, and menthol was then added to the charcoal foam in the form of droplets. The charcoal foam was then cut to the required shape and thickness.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A consumable for a vapour provision device comprising:
a porous carbon-based foam configured to hold a vapour precursor material,
wherein the porous carbon-based foam is electrically conductive and is configured to make electric contact with one or more electrodes to receive an electric current,
wherein the porous carbon-based foam is configured to increase in temperature to volatilise at least some of the vapour precursor material when electric current is received from the one or more electrodes,
wherein the porous carbon-based foam is configured to become granular when exhausted of vapour precursor material.

2. The consumable according to claim 1, wherein the foam's structure is maintained by a binder material.

3. The consumable according to claim 1, wherein the binder material comprises glycerol.

4. The consumable according to claim 3, wherein the binder is present in an amount of between 5 and 40 wt. % based on the total weight percentage of the carbon-based foam prior to drying.

5. The consumable according to claim 1, wherein the porous carbon-based foam comprises charcoal.

6. The consumable according to claim 5, wherein the charcoal is present in an amount of between 10 to 60% wt., based on the total weight percentage of the carbon-based foam prior to drying.

7. The consumable according to claim 1, wherein the foam comprises a flexilibising agent.

8. The consumable according to claim 1, wherein the consumable comprises a cooling section at an inlet end.

9. The consumable according to claim 1, wherein the consumable includes conductive layers on a periphery to electrically couple with said one or more electrodes.

10. The consumable according to claim 1, wherein the consumable has a substantially cuboidal shape.

11. The consumable according to claim 1, wherein the consumable is flat shaped.

12. The consumable according to claim 1, wherein the consumable includes one or more reservoirs for holding vapour precursor material, wherein the porous carbon-based foam is configured to wick the vapour precursor material from the one or more reservoirs during use.

13. The consumable according to claim 1, wherein the vapour precursor material is self-contained in the porous carbon-based foam.

14. A system comprising:
a vapour provision device comprising electrodes; and
the consumable according to claim 1.

15. A method of manufacturing a consumable for a vapour provision device comprising:
combining a base material, a flexilibising agent, a binder, water and charcoal together to form an intermediate;
pressing and heating the intermediate to evaporate the water to create pores; and
applying a vapour precursor material to the intermediate.
